(19) United States
(12) Patent Application Publication
(10) Pub. No.: US 2021/0166148 A1
(43) Pub. Date: Jun. 3, 2021

(54) VARIATIONALLY AND ADIABATICALLY NAVIGATED QUANTUM EIGENSOLVERS

(71) Applicant: 1QB Information Technologies Inc., Vancouver (CA)

(72) Inventors: Shunji MATSUURA, Vancouver (CA); Takeshi YAMAZAKI, Vancouver (CA); Arman ZARIBAFIYAN, Vancouver (CA); Pooya RONAGH, Vancouver (CA)

(21) Appl. No.: 17/122,828

(22) Filed: Dec. 15, 2020

Related U.S. Application Data
(63) Continuation of application No. PCT/CA2019/050852, filed on Jun. 17, 2019.
(60) Provisional application No. 62/686,594, filed on Jun. 18, 2018.

(51) Int. Cl. G06N 10/00; G06F 17/18

(52) U.S. Cl. CPC G06N 10/00; G06N 20/00; G06F 17/18

(57) ABSTRACT

The present disclosure provides methods and systems for solving an optimization problem using a computing platform comprising at least one non-classical computer and at least one digital computer. The at least one non-classical computer may be configured to perform an adiabatic quantum computation with a first Hamiltonian and second Hamiltonian.

### CROSS-REFERENCE

This application is a continuation of PCT International Application No. PCT/CA2019/050852, filed Jun. 17, 2019, which claims the benefit of U.S. Provisional Patent Application Ser. No. 62/686,594, filed on Jun. 18, 2018 each of which is incorporated herein by reference in their entirety.

### BACKGROUND

Various industrial and scientific problems can be formulated as minimization of cost functions. As an example, in chemistry, physics, and biology, a prediction of the most stable configuration(s) of a quantum system has significant importance. This problem can be formulated as obtaining the ground state of a Hamiltonian. In order to obtain a desirable result, e.g., of an improved or optimized cost function, such as predicting an accurate chemical reaction rate, highly precise numerical methods may be required. Non-limiting examples of the numerical methods include an exact diagonalization method, and coupled-cluster theory with single and double excitation operators. However, the computational cost of these numerical methods on a classical computer may become exponentially large, especially when the size of a quantum system such as a molecular size increases. Even with a state-of-art supercomputer, it can be difficult to exactly diagonalize a molecular Hamiltonian with more than about five atoms.

### SUMMARY

Adiabatic quantum computation is a quantum algorithm that can be used, in some cases by a quantum computer, to find a configuration that can minimize or optimize a cost function. With its quantum nature, it may require much less computational resource to simulate quantum systems than using numerical methods on classical computers. In addition, simulating a quantum system on a quantum computer, e.g., annealer, can be scalable.

The quantum algorithm of adiabatic quantum computation can be based on a quantum adiabatic theorem: when a Hamiltonian changes adiabatically, the quantum state may stay on the instantaneous ground state. A consequence of this theorem can be that if a time dependent Hamiltonian adiabatically evolves from a simple Hamiltonian, whose ground state is easy to prepare, to a Hamiltonian which represents an optimization problem, then the final quantum state obtained after the time evolution can be the optimal solution of the problem.

In order to satisfy a quantum adiabatic condition, various parameters (e.g., amplitude of a Hamiltonian) of a quantum algorithm may be changed more slowly than the scale of the energy gap between the instantaneous ground state and excited states. If the energy gap of a chosen adiabatic path becomes very small, adiabatic quantum computation may become very inefficient. Therefore, it can be important to find a path on which the energy gap stays open. Another important approach to finding an improved evolution path can be the coherence time. Any quantum device can be exposed by noise, and it may become harder to keep quantum information protected from noise if the computation time becomes longer. It may be a challenging problem to extend a coherence time of a quantum device longer than a total computation time. Therefore, it may be important to find a method to shortening the computation time without losing the accuracy of computational results.

The present disclosure can advantageously enable a significant reduction of a non-classical (e.g., quantum) computational time. The present disclosure can be applicable not only to solve quantum optimization problems but also classical optimization problems. The present disclosure focuses on systems and methods for advantageously using a hybrid architecture of quantum and classical devices to efficiently estimate the optimal value of the cost function(s). The cost function(s) may be of quantum optimization problem, classical optimization problems, and/or combinatorial optimization problems.

In one aspect, disclosed herein is a computer-implemented method for solving an optimization problem using a computing platform comprising at least one non-classical computer and at least one digital computer, comprising: (a) determining, by the at least one digital computer, one or more first parameters of a first Hamiltonian; (b) using said one or more first parameters to configure a second Hamiltonian; (c) using said at least one non-classical computer to execute said second Hamiltonian to obtain a solution of the second Hamiltonian; (d) processing said solution to determine a value of a cost function associated with (i) said second Hamiltonian or (ii) execution of said second Hamiltonian by said at least one non-classical computer; and (e) subsequent to (d), (i) outputting a result indicative of said solution if said value meets a threshold value, or (ii) using one or more second parameters to reconfigure said second Hamiltonian, which one or more second parameters are different than said one or more first parameters.

The first Hamiltonian may comprise an intermediate Hamiltonian. The second Hamiltonian may comprise a final Hamiltonian. The second Hamiltonian may comprise a plurality of different types of Hamiltonians. One or more coefficients of the plurality of different types of Hamiltonians may be time-dependent. One or more coefficients of the plurality of different types of Hamiltonians may be time-independent. One or more coefficients of the final Hamiltonian can be time-dependent. One or more coefficients of the final Hamiltonian can be time-independent. The one or more parameters of the first Hamiltonian may comprise one or more variational parameters.

The method may further comprise, prior to (a), receiving, by the at least one digital computer, a cost function of the optimization problem. The method may further comprise, prior to (a), initializing, by the at least one digital computer, a list of parameters and solutions. The list of parameters and solutions, upon initialization, can be empty. The method may further comprise, prior to (a), determining the first Hamiltonian. Determining the first Hamiltonian can be based on one or more members selected from the group consisting of: the optimization problem, a cost function of the optimization problem, and a final Hamiltonian related to the cost function. The first Hamiltonian may not be unique. Operation (a) may comprise (i) setting the list of parameters and solutions to be zero if in a first iteration; (ii) updating, by the at least one digital computer, the list of parameters and solutions with the one or more parameters and the solution, if in an iteration subsequent to the first iteration. Operation (a) may comprise using one or more optimizers selected from the group consisting of: a Bayesian optimization method, black-box optimization, gradient-free optimization, gradient-based optimization, a first-order or second-order method, a gradient descent method, a stochastic gradient decent method, and an adaptive gradient descent method. Operation (a) may comprise using one or more optimizers selected from the group consisting of: a Nelder-Mead method, a Powell method, constrained optimization by linear approximation (COBYLA), and a Broyden-Fletcher-Goldfarb-Shanno (BFGS) method. Operation (a) may comprise using one or more artificial intelligence (AI) optimization algorithms to determine the one or more parameters of the first Hamiltonian. Operation (b) may comprise determining, by the at least one digital computer, one or more parameters of the second Hamiltonian. Operation (b) may comprise determining a schedule for changing the one or more parameters of the first Hamiltonian or one or more parameters of the second Hamiltonian. Operation (b) may comprise determining a schedule for changing the one or more parameters of the first Hamiltonian and one or more parameters of the second Hamiltonian. Determining the schedule may comprise determining a duration of time for annealing. Operation (c) can be performed based at least in part on the schedule. Operation (c) can comprise determining an encoding scheme variationally and obtaining information of the encoding scheme. Operation (c) can comprise obtaining a qubit Hamiltonian of the first Hamiltonian or the second Hamiltonian. Operation (c) can comprise obtaining a qubit Hamiltonian of the first Hamiltonian and the second Hamiltonian. Operation (c) may comprise (i) preparing an initial state of one or more qubits of the at least one non-classical computer and (ii) performing adiabatic quantum computation on an optimization device. The optimization device may a quantum annealer or a digital annealer. Operation (c) may comprise generating a result state of the one or more qubits and obtaining one or more measurements of the result state thereby obtaining the solution. The non-classical computer may be a quantum computer. The non-classical computer may be a quantum-ready or a quantum-enabled computer. The threshold value may be a threshold energy that is predetermined by a user or a computer. The optimization problem may comprise one or more members selected from the group consisting of a non-classical optimization problem and a classical optimization problem.

In another aspect, disclosed herein is a system for solving an optimization problem comprising: a computing platform comprising at least one non-classical computer and at least one digital computer; computer memory; and one or more computer processors operatively coupled to the computer memory, wherein the one or more computer processors are individually or collectively programmed to: (a) determine, by the at least one digital computer, one or more first parameters of a first Hamiltonian; (b) use the one or more first parameters to configure the first Hamiltonian and a second Hamiltonian; (c) use the at least one non-classical computer to execute the second Hamiltonian to obtain a solution of the second Hamiltonian; (d) process the solution to determine a value of a cost function associated with (i) the second Hamiltonian or (ii) execution of the second Hamiltonian by the at least one non-classical computer; and (e) subsequent to (d), (i) output a result indicative of the solution if the value meets a threshold value, or (ii) use one or more second parameters to reconfigure the second Hamiltonian, which one or more second parameters are different than the one or more first parameters.

In another aspect, disclosed herein is a non-transitory computer readable medium comprising machine-executable code that, upon execution by one or more computer processors, implements a method for solving an optimization problem using a computing platform comprising at least one non-classical computer and at least one digital computer, said method comprising, the method comprising: (a) determining, by the at least one digital computer, one or more first parameters of a first Hamiltonian; (b) using the one or more first parameters to configure a second Hamiltonian different than the first Hamiltonian; (c) using the at least one non-classical computer to execute the second Hamiltonian to obtain a solution of the second Hamiltonian; (d) processing the solution to determine a value of a cost function associated with (i) the second Hamiltonian or (ii) execution of the second Hamiltonian by the at least one non-classical computer; and (e) subsequent to (d), (i) outputting a result indicative of the solution if the value meets a threshold value, or (ii) using one or more second parameters to reconfigure the second Hamiltonian, which one or more second parameters are different than the one or more first parameters.

Another aspect of the present disclosure provides a non-transitory computer readable medium comprising machine executable code that, upon execution by one or more computer processors, implements any of the methods above or elsewhere herein.

Another aspect of the present disclosure provides a system comprising one or more computer processors and computer memory coupled thereto. The computer memory comprises machine executable code that, upon execution by the one or more computer processors, implements any of the methods above or elsewhere herein.

Additional aspects and advantages of the present disclosure will become readily apparent to those skilled in this art from the following detailed description, wherein only illustrative embodiments of the present disclosure are shown and described. As will be realized, the present disclosure is capable of other and different embodiments, and its several details are capable of modifications in various obvious respects, all without departing from the disclosure. Accordingly, the drawings and description are to be regarded as illustrative in nature, and not as restrictive.

### INCORPORATION BY REFERENCE

All publications, patents, and patent applications mentioned in this specification are herein incorporated by reference to the same extent as if each individual publication, patent, or patent application was specifically and individually indicated to be incorporated by reference. To the extent publications and patents or patent applications incorporated by reference contradict the disclosure contained in the specification, the specification is intended to supersede and/or take precedence over any such contradictory material.

### BRIEF DESCRIPTION OF THE DRAWINGS

The novel features of the invention are set forth with particularity in the appended claims. A better understanding of the features and advantages of the present invention will be obtained by reference to the following detailed description that sets forth illustrative embodiments, in which the principles of the invention are utilized, and the accompanying drawings (also “Figure,” “Fig.,” and “FIG.” herein), of which:

FIG. 1 shows a non-limiting example of a flowchart of a method for minimizing a cost function using a non-classical computer (e.g., hybrid architecture of non-classical or quantum computers and digital computers);

FIG. 2 shows a non-limiting example of a flowchart of a method for providing an indication of the expectation value of the Hamiltonian on non-classical or quantum computers;

FIG. 3 schematically illustrates a hybrid architecture of a non-classical or quantum computer and a classical computer.

FIGS. 4A-4B show estimated energy as a function of annealing time using the systems and methods provided herein;

FIG. 5 schematically illustrates the required time to reach chemical accuracy for a P4 molecule with various values of intermolecular distances;

FIGS. 6A-6B schematically illustrates the energy gap and the wavefunction overlap for a hydrogen molecule as a function of computational time, respectively;

FIG. 7 schematically illustrates the estimated energy as a function of annealing time by using systems and methods provided herein with and without noise;

FIG. 8 schematically illustrates a non-limiting example of a method to determine an annealing schedule variationally; and

FIG. 9 schematically illustrates estimated energy as a function of annealing time with and without noise while employing a variationally determined annealing schedule within the context of the systems and methods provided herein.

### DETAILED DESCRIPTION

While various embodiments of the invention have been shown and described herein, it will be obvious to those skilled in the art that such embodiments are provided by way of example only. Numerous variations, changes, and substitutions may occur to those skilled in the art without departing from the invention. It should be understood that various alternatives to the embodiments of the invention described herein may be employed.

Unless otherwise defined, all technical terms used herein have the same meaning as commonly understood by one of ordinary skill in the art to which this invention belongs.

As used herein, the singular forms “a,” “an,” and “the” include plural references unless the context clearly dictates otherwise. Any reference to “or” herein is intended to encompass “and/or” unless otherwise stated.

Whenever the term “at least,” “greater than,” or “greater than or equal to” precedes the first numerical value in a series of two or more numerical values, the term “at least,” “greater than” or “greater than or equal to” applies to each of the numerical values in that series of numerical values. For example, greater than or equal to 1, 2, or 3 is equivalent to greater than or equal to 1, greater than or equal to 2, or greater than or equal to 3.

Whenever the term “no more than,” “less than,” or “less than or equal to” precedes the first numerical value in a series of two or more numerical values, the term “no more than,” “less than,” or “less than or equal to” applies to each of the numerical values in that series of numerical values. For example, less than or equal to 3, 2, or 1 is equivalent to less than or equal to 3, less than or equal to 2, or less than or equal to 1.

Where values are described as ranges, it will be understood that such disclosure includes the disclosure of all possible sub-ranges within such ranges, as well as specific numerical values that fall within such ranges irrespective of whether a specific numerical value or specific sub-range is expressly stated.

In the following detailed description, reference is made to the accompanying figures, which form a part hereof. In the figures, similar symbols typically identify similar components, unless context dictates otherwise. The illustrative embodiments described in the detailed description, figures, and claims are not meant to be limiting. Other embodiments may be utilized, and other changes may be made, without departing from the scope of the subject matter presented herein. It will be readily understood that the aspects of the present disclosure, as generally described herein, and illustrated in the figures, can be arranged, substituted, combined, separated, and designed in a wide variety of different configurations, all of which are explicitly contemplated herein.

As used herein, the term “classical,” as used in the context of computing or computation, generally refers to computation performed using binary values using discrete bits without use of quantum mechanical superposition and quantum mechanical entanglement. A classical computer may be a digital computer, such as a computer employing discrete bits (e.g., 0's and 1's) without use of quantum mechanical superposition and quantum mechanical entanglement.

As used herein, the term “non-classical,” as used in the context of computing or computation, generally refers to any method or system for performing computational procedures outside of the paradigm of classical computing. A non-classical computer may perform computations using quantum mechanical superposition and quantum mechanical entanglement.

As used herein, the terms “quantum computation,” “quantum procedure,” “quantum operation,” and “quantum computer” generally refer to any method or system for performing computations using quantum mechanical operations (such as unitary transformations or completely positive trace-preserving (CPTP) maps on quantum channels) on a Hilbert space represented by a quantum device. As such, quantum and classical (or digital) computation may be similar in the following aspect: both computations may comprise sequences of instructions performed on input information to then provide an output. Various paradigms of quantum computation may break the quantum operations down into sequences of basic quantum operations that affect a subset of qubits of the quantum device simultaneously. The quantum operations may be selected based on, for instance, their locality or their ease of physical implementation. A quantum procedure or computation may then consist of a sequence of such instructions that in various applications may represent different quantum evolutions on the quantum device. For example, procedures to compute or simulate quantum chemistry may represent the quantum states and the annihilation and creation operators of electron spin-orbitals by using qubits (such as two-level quantum systems) and a universal quantum gate set (such as the Hadamard, controlled-not (CNOT), and π/8 rotation) through the so-called Jordan-Wigner transformation or Bravyi-Kitaev transformation.

Additional examples of quantum procedures or computations may include procedures for optimization such as quantum approximate optimization algorithm (QAOA) or quantum minimum finding. QAOA may comprise performing rotations of single qubits and entangling gates of multiple qubits. In quantum adiabatic computation, the instructions may carry stochastic or non-stochastic paths of evolution of an initial quantum system to a final one.

The present disclosure provides systems and methods that advantageously use an intermediate Hamiltonian having variational parameters to generate solutions with value(s) that optimize a cost function in a rapid and accurate manner. This may advantageously enable users to efficiently identify an optimal state, e.g., the ground state, of a quantum system. In the present disclosure, finding such an optimal state can be achieved through a quantum annealing process that utilizes an intermediate Hamiltonian. The parameters of the intermediate Hamiltonian can be iteratively improved or optimized in order for the annealing process to converge to the ground state of the quantum system with a shorter annealing time.

In an aspect, the present disclosure provides a computer-implemented method for solving an optimization problem using a computing platform comprising at least one non-classical computer and at least one digital computer. The method may comprise determining, by the at least one digital computer, one or more first parameters of a first Hamiltonian. Next, the one or more first parameters may be used to configure a second Hamiltonian different than the first Hamiltonian. The at least one non-classical computer may then execute the second Hamiltonian to obtain a solution of the second Hamiltonian. Next, the solution may be processed to determine a value of a cost function associated with (i) the second Hamiltonian or (ii) execution of the second Hamiltonian by the at least one non-classical computer. Finally, a result indicative of the solution may be output if the value meets a threshold value. Alternatively, one or more second parameters may be used to reconfigure the second Hamiltonian. The one or more second parameters may be different than the one or more first parameters.

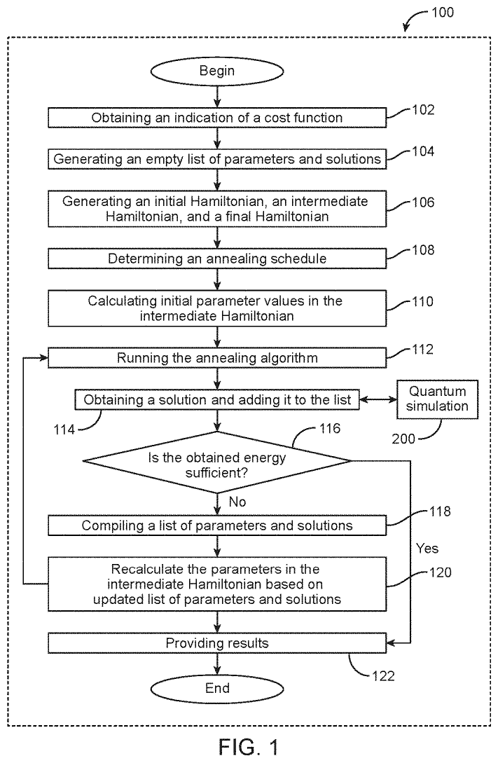

FIG. 1 shows a flowchart for a method 100 of solving an optimization problem using at least two types of Hamiltonians. The method may also be referred to as variationally navigated quantum solver (VanQver). This optimization problem may be solved by a non-classical computer, such as a quantum computer, a hybrid architecture comprising a quantum computer and a digital computer, or a digital computer. Referring to FIG. 1, in operation 102 an indication of a cost function is obtained. The cost function can be related to any type of optimization problems such as non-classical, classical, and/or combinatorial optimization problems. A cost function can be selected depending on an objective of a problem, e.g., an industrial and/or scientific problem. For example, a cost function may be the expectation value of a molecular Hamiltonian or the variance of a molecular Hamiltonian if the objective is obtaining the ground state or excited states of a molecular system. As another example, a cost function may be chosen to be the fidelity of quantum states if the objective is error correction. The cost function may be obtained manually by a user or automatically by a computer program.

The cost function may be selected so that the solution (e.g., optimal solution) gives a value of the cost function that satisfies one or more criteria. For example, the solution may give a lowest value of the cost function. As another example, the solution may give a value of the cost function that is lower than a determined threshold within a determined time frame for computation.

With continued reference to FIG. 1, an empty list of the parameters and solutions may be generated in operation 104, in some cases prior or subsequent to determination of a cost function. The empty list can be updated repetitively after one or more iterations, in some cases. For example, the empty list may be updated to include values of one or more parameters and the solution for each iteration of quantum annealing. The parameters may be configurable to control or influence the time evolution of a quantum state of a quantum system to be improved or optimized, e.g., a molecule, in adiabatic quantum computation. The parameters may be configurable to control or influence the solution(s) and the value(s) of the cost function obtained by adiabatic quantum computation.

The values of one or more parameters of the variational parameters herein can be varied. The parameters may include one or more time-dependent coefficients that control the amplitude of one or more Hamiltonians (e.g., initial, intermediate, and/or final Hamiltonians) throughout the annealing process. The parameters may include a set of time-independent coefficients corresponding to the amplitudes of the terms inside the intermediate Hamiltonian and/or other Hamiltonians.

For example, in a quantum chemistry simulation, the intermediate Hamiltonian can be one obtained from the unitary coupled cluster operator and therefore the parameters can include the set of amplitudes in that unitary coupled cluster Hamiltonian. The intermediate Hamiltonian may also be referred to as a navigator Hamiltonian herein.

Hamiltonians can be used by the systems and methods described herein in the adiabatic evolution or adiabatic quantum computation. There can be at least about two, three, four, five, six, seven, eight, nine, ten, or more types of Hamiltonians. There may be at most about ten, nine, eight, seven, six, five, four, three, or two types of Hamiltonians. There may be a number of Hamiltonians that is within a range defined by any two of the preceding values. For example, to find the optimal state of the quantum system, an initial Hamiltonian, an intermediate Hamiltonian (e.g., first Hamiltonian), and a final Hamiltonian (e.g., second Hamiltonian) may be used. Alternatively, or in combination, there can be a Hamiltonian combining at least about one, two, three, four, five, six, seven, eight, nine, ten, or more different types of Hamiltonians, at most about ten, nine, eight, seven, six, five, four, three, two, or one different types of Hamiltonians, or a number of Hamiltonians that is within a range defined by any two of the preceding values (e.g., combining the first and/or the second Hamiltonian with a third Hamiltonian, the third Hamiltonian being not the initial, intermediate, or final Hamiltonian).

With continued reference to FIG. 1, at operation 106, one or more of the initial Hamiltonian, the intermediate Hamiltonian (e.g., first Hamiltonian), and the final Hamiltonian may be generated or determined. The final Hamiltonian can be generated based on the cost function. If the objective of the computation is to obtain the ground state of a quantum system, the final Hamiltonian can be identical to the Hamiltonian of the quantum system itself. In the case of solving a combinatorial optimization problem, the final Hamiltonian may be a classical Ising Hamiltonian whose ground state may provide the solution of the optimization problem.

An initial and/or an intermediate Hamiltonian may not be uniquely determined. An initial and/or an intermediate Hamiltonian can be determined based on but not limited to one or more of: an optimization problem, an objective of the problem, a cost function of said optimization problem, and a final Hamiltonian related to said cost function. General requirements for an appropriate initial Hamiltonian may include but are not limited to: 1) the ground state of the initial Hamiltonian is easy to prepare, and 2) the ground state of the initial Hamiltonian is reachable to the true ground state of the final Hamiltonian by adiabatic evolution or adiabatic quantum computation. An initial and/or an intermediate Hamiltonian can be determined manually by a user or automatically by a computer program.

An intermediate Hamiltonian can be introduced in the systems and methods described herein so that it helps the quantum state of the quantum system to be improved or optimized to reach as close as possible to the true ground state of the final Hamiltonian at the end of the adiabatic quantum computation within a fixed total annealing time. Such intermediate Hamiltonian can also be introduced so that it helps the quantum state to reach as close as possible to the true ground state of the final Hamiltonian faster than systems and methods without the intermediate Hamiltonian. The coefficients in an intermediate Hamiltonian can be variational parameters (e.g., time-dependent) and can be chosen so that an evaluated cost function becomes lower.

The final Hamiltonian H_{final} nal may be a second quantized electron Hamiltonian of a molecular system, which may take the following form:

H_{final}=Σ_{pq}h_{pq}\hat{α}ₚ^{†}\hat{α}_{q}+Σ_{pqrs}h_{pqrs}\hat{α}ₚ^{†}\hat{α}ᵣ^{†}\hat{α}ᵣ\hat{α}ₛ (1)

where \hat{α}^{†}(\hat{α}) is an electron creation (annihilation) operator and p, q, r, s represent spin-orbitals, and h_{pq} and h_{pqrs} are the one and two electron integrals and can be obtained (or calculated) by considering the physics of the molecular system. h_{pq} and h_{pqrs} can be provided as part of the input to the systems and methods described herein. The initial Hamiltonian can be selected as the Hartree Fock Hamiltonian H_{HF}:

H_{HF}=Σ_{pq}h_{pq}^{HF}\hat{α}ₚ^{†}\hat{α}_{q} (2)

which can be obtained from (1). It is also possible to use the post Hartree Fock Hamiltonian as the initial Hamiltonian.

An intermediate Hamiltonian H_{intermediate} may include single and/or double excitation operators, as follows:

H_{intermediate}=Σ_{p,α}\tilde{h}_{pα}\hat{α}_{α}^{†}\hat{α}ₚ+Σ_{p,q,α,β}\tilde{h}_{pqαβ}\hat{α}_{α}^{†}\hat{α}_{β}^{†}\hat{α}ₚ\hat{α}_{q}+h.c. (3)

where p, q are occupied states for the Hartree Fock wavefunction and α,β are unoccupied states. h. c. represents the Hermitian conjugate. Additional terms such as higher order excitation operators can be added to the intermediate Hamiltonian.

In the case of a combinatorial optimization problem, the final Hamiltonian can be the problem Hamiltonian of the optimization problem whereas the initial Hamiltonian can be the uniform local transverse field. An intermediate Hamiltonian may have a form as the following:

H_{intermediate}Σ_{i,j}h_{i,j}σᵢ^{x}σⱼ^{x} (4)

where σ^{x} is the x component of the Pauli matrix, h_{i,j} are variational parameters, i, j are qubit indices.

With continued reference to FIG. 1, an annealing schedule may be determined at operation 108. The annealing schedule may be determined at least in part by determining the time evolution of the quantum system to be improved or optimized. The annealing schedule may include the duration of the annealing. The total duration of the annealing process can be an important factor in success rate of the methods and systems described herein and their time complexity.

Determining the annealing schedule may also involve how and/or when to change the amplitudes of one or more of the three types of Hamiltonian (e.g., the initial, intermediate, and final Hamiltonians) throughout the annealing process. The annealing schedule may include changing the overall coefficients of the three Hamiltonians to vary with annealing time t as A(t), B(t), and CO, respectively:

H(t)=A(t)Hᵢₙᵢₜᵢₐₗ+B(t)H_{intermediate}+C(t)H_{final} (5)

where A(0)>>B(0), C(0) and C(T)>>A(T),B(T) with the total annealing time T, and annealing time t ranges from 0 to T.

Each individual coefficient in the one or more types of Hamiltonians described herein can have different time dependence as following

Jᵢⱼ(t) (6)

with a boundary condition Jᵢⱼ (0)=Jᵢⱼ(T)=0 for all i, j, which can be multiplied to terms in equation (4), wherein i, j are qubit indices.

With continued reference to FIG. 1, in operation 110, the initial values for the one or more variational parameters of the intermediate Hamiltonian may be determined. The initial values of these variational parameters may be set prior to execution of quantum annealing. The initial values may be set manually by a user or automatically by a digital computer. Initial values of one or more of the variational parameters can be set to be zero. Additionally, or in combination, initial values for the one or more variational parameters of one or more other Hamiltonians, e.g., initial and/or final Hamiltonians may also be set.

The variational parameters may be used to configure the intermediate Hamiltonian thereby yielding a second Hamiltonian which may include one, two, three, or even more different Hamiltonians (e.g., initial, intermediate, and final Hamiltonians).

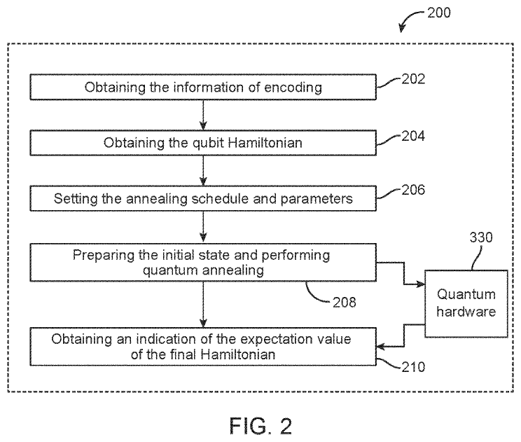

With continued reference to FIG. 1, in operation 112, adiabatic quantum computation may be operated using the second Hamiltonian thereby obtaining a solution. Operating the adiabatic quantum computation 112 may include simulation of the quantum system to be improved or optimized in method 200 as shown in FIG. 2.

FIG. 2 shows a flowchart for a method 200 for providing an indication of the expectation value of the Hamiltonian on non-classical or quantum computers. In operation 202, information of an encoding scheme may be obtained for the quantum simulation. Obtaining information of the encoding scheme can include determining the encoding scheme.

The bottleneck of adiabatic quantum computation may be to protect quantum states from external noise as well as keeping the quantum state(s) on the instantaneous ground state. To resolve the bottleneck, multiple qubits may be used to describe one unit of quantum information. This process can be called encoding. The scheme of encoding may be determined variationally. To store one unit of information on a quantum device and preserve it from noise, it can be common to use multiple physical qubits as an error correction scheme in encoding. Storing a unit of quantum information out of multi-qubits may not be uniquely determined. The systems and methods described herein variationally determine the encoding scheme, such as how many qubits to be used, how they are coupled to each other, and/or the coupling strength of them.

As an example, suppose an combinatorial optimization problem is to be solved whose cost function is:

H=Σ_{i,j}J_{i,j}σᵢ^{z}σⱼ^{z}+Σᵢhᵢσᵢ^{z} (7)

where σ^{z} is the z component of the Pauli matrix, representing one bit of quantum information, and J_{i,j} and hᵢ are coefficients. In an error correction scheme considered in [2-4], this information may be multiplied C times:

σᵢ^{z}→Σ_{c,c′=1}^{C}γ_{(ic,ic′)}σ_{(i,c)}^{z}σ_{(i,c′)}^{z} (8)

The C may represent spin, which is called a logical qubit, and represents one unit of quantum information. The coupling parameters γ_{(ic,ic′)} can be variational parameters.

With continued reference to FIG. 2, in operation 204, the second Hamiltonian, e.g., the initial, the intermediate and/or the final Hamiltonians, may be translated into a qubit Hamiltonian if the initial, the intermediate and/or the final Hamiltonian are not written in terms of qubits.

For example, in the case of second quantized molecular Hamiltonian, Jordan-Wigner transformation or Bravyi-Kitaev transformation can be used to change from second quantized operators into Pauli operators. The Jordan-Wigner transformation of a molecular Hamiltonian can be as follows:

H=Σ_{pqrs}Σ_{abcd}g_{pqrs}^{abcd}⊗_{p>i>q}σᵢ^{z}⊗_{r>j>s}σⱼ^{z}(σₚ^{a}σ_{q}^{p}σᵣ^{c}σₛ^{d}) (9)

With continued reference to FIG. 2, the annealing schedule and the parameters can be set in operation 206 based on operations such as 106 and 108 in FIG. 1. After setting the annealing schedule, the initial state of the quantum system to be improved or optimized may be prepared, and adiabatic quantum computation may be performed in operation 208. The initial state can be pertaining to the initial state of the qubits in a quantum device. If the initial state is close to the target ground state (e.g., the lowest Eigen value of the final Hamiltonian), then the quantum anneal may have a higher probability of success (e.g., satisfying the threshold with high accuracy or finding a value satisfying the threshold faster).

After performing the adiabatic quantum computation, an indication of the expectation value of the final Hamiltonian may be obtained by using the resulting state 210. The quantum device described herein may comprise one or more qubits. The quantum annealing can be a time-dependent operation that is applied to the initial state of the qubit(s). At the end of each iteration of quantum annealing, the resulting state of the quantum system to be improved or optimized or the resulting state of the qubit(s) can be measured, read, and/or stored. In order to obtain the expectation value of the final Hamiltonian, individual terms in the final Hamiltonian may need to be measured sufficiently many times. For each measurement, a quantum state with a given set of parameters may need to be newly generated on quantum hardware. The expectation value of the final Hamiltonian can be obtained by the summation of the expectation values of the individual terms in the final Hamiltonian. This method has been indicated previously in various works, for example, in O'Malley, P. J. J. et al., “Scalable Quantum Simulation of Molecular Energies”, Phys. Rev. X 6, 031007 (2016), which is entirely incorporated herein by reference.

Alternatively or in combination, methods to group individual terms in the Hamiltonian to reduce the number of required repetitions may be applied.

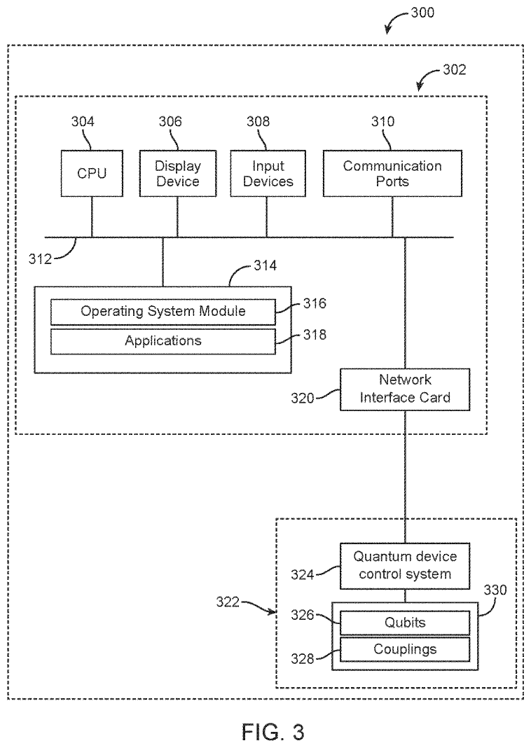

The adiabatic quantum computation can be performed on quantum hardware described herein (such as quantum hardware 330 described herein with respect to FIG. 3). Quantum hardware described herein may include one or more quantum device such as a quantum annealer or a quantum computer. The adiabatic quantum computation described herein may not be limited to quantum annealing or quantum adiabatic devices. Alternatively, or in combination, the adiabatic quantum computation can be performed on a classical device such as a digital annealer. The adiabatic quantum computation can be performed as simulation of quantum annealing on a classical computer. The adiabatic quantum computation can be implemented as a digital version via trotterization (e.g., quantum approximate optimization algorithm (QAOA)) on a gate model quantum computer.

Returning to the description of FIG. 1, after the adiabatic quantum computation is performed, a solution may be obtained in operation 114. The solution can relate to the measurement of the resulting state. Such solution can be used to determine a value of the cost function. Such solution may include a value of the cost function.

The solution (e.g., the value of the cost function) and parameters used to generate the solution, can be added to the list of the parameters and solutions in operation 114. Information other than parameters and solution in the adiabatic quantum computation may also be added to the list of the parameters, such as the total annealing time or computational cost.

The obtained value of the cost function can be evaluated to determine if it is sufficient or not in operation 116. The obtained value may be related to a value of energy. Evaluation may include comparison to a threshold energy obtained from a computer program and/or a user-defined value. The threshold energy can determine how accurate the estimation of the lowest energy should be. The threshold energy can be dependent on the specific application and/or the user's expectations. For example, in a quantum chemistry energy estimation application, the chemical accuracy of 1 Kcal/mol can be used as threshold. If it is sufficient, then the systems and methods may proceed to provide the result indicative of the solution, the value of the cost function, and/or the measurement of the resulting state, in some cases to the user in operation 122. If it is not sufficient, then a list of parameters and solutions can be compiled to include at least the parameters and solution of the currently iteration in operation 118. Then the parameters of the intermediate Hamiltonian can be recalculated or updated based on the compiled list of parameters and solutions in operation 120. The recalculated or updated parameters and solution(s) can be saved into the list of parameters and solutions with or without overwriting previously saved parameters or solutions in the list.

Updating or recalculating the list of parameters and solutions may include recording or saving values of one or more parameters and/or solutions of the current iteration and/or one or more previous iterations. Updating said list of parameters and solutions may use but may not be limited to one or more optimizers selected from the group consisting of: a Bayesian optimization method, a black-box optimization, a gradient-free optimization, a gradient-based optimization, a first-order or second-order method, a gradient descent method, a stochastic gradient decent method, and an adaptive gradient descent method. Nonlimiting examples of optimizers include: Nelder-Mead methods, Powell methods, constrained optimization by linear approximation (COBYLA), and Broyden-Fletcher-Goldfarb-Shanno (BFGS) methods.

Artificial intelligence (AI) techniques can be used to find better parameters for updating or recalculating the list of parameters and solutions. An AI technique, procedure, operation, or algorithm may comprise any technique, procedure, operation, or algorithm that takes one or more actions to enhance or maximize a chance of achieving a goal. An AI technique, procedure, operation, or algorithm may comprise a machine learning (ML) or reinforcement learning (RL) technique, procedure, operation, or algorithm.

An ML technique, procedure, operation, or algorithm may comprise any technique, procedure, operation, or algorithm that progressively improves computer performance of a task. A machine learning algorithm may be a trained algorithm. Machine learning (ML) may comprise one or more supervised, semi-supervised, or unsupervised machine learning techniques. For example, an ML algorithm may be a trained algorithm that is trained through supervised learning (e.g., and various parameters are determined as weights or scaling factors). ML may comprise one or more of regression analysis, regularization, classification, dimensionality reduction, ensemble learning, meta learning, association rule learning, cluster analysis, anomaly detection, deep learning, or ultra-deep learning. ML may comprise, but is not limited to: k-means, k-means clustering, k-nearest neighbors, learning vector quantization, linear regression, non-linear regression, least squares regression, partial least squares regression, logistic regression, stepwise regression, multivariate adaptive regression splines, ridge regression, principle component regression, least absolute shrinkage and selection operation, least angle regression, canonical correlation analysis, factor analysis, independent component analysis, linear discriminant analysis, multidimensional scaling, non-negative matrix factorization, principal components analysis, principal coordinates analysis, projection pursuit, Sammon mapping, t-distributed stochastic neighbor embedding, AdaBoosting, boosting, gradient boosting, bootstrap aggregation, ensemble averaging, decision trees, conditional decision trees, boosted decision trees, gradient boosted decision trees, random forests, stacked generalization, Bayesian networks, Bayesian belief networks, naïve Bayes, Gaussian naïve Bayes, multinomial naïve Bayes, hidden Markov models, hierarchical hidden Markov models, support vector machines, encoders, decoders, auto-encoders, stacked auto-encoders, perceptrons, multi-layer perceptrons, artificial neural networks, feedforward neural networks, convolutional neural networks, recurrent neural networks, long short-term memory, deep belief networks, deep Boltzmann machines, deep convolutional neural networks, deep recurrent neural networks, or generative adversarial networks.

An RL technique, procedure, operation, or algorithm may comprise any technique, procedure, operation, or algorithm that takes one or more actions to enhance or maximize some notion of a cumulative reward to its interaction with an environment. The agent performing the reinforcement learning (RL) procedure (such as a classical, non-classical, or quantum computer) may receive positive or negative reinforcements, called an “instantaneous reward”, from taking one or more actions in the environment and therefore placing itself and the environment in various new states. A goal of the agent may be to enhance or maximize some notion of cumulative reward. For instance, the goal of the agent may be to enhance or maximize a “discounted reward function” or an “average reward function”. A “Q-function” may represent the maximum cumulative reward obtainable from a state and an action taken at that state. A “value function” and a “generalized advantage estimator” may represent the maximum cumulative reward obtainable from a state given an optimal or best choice of actions. RL may utilize any one of more of such notions of cumulative reward. As used herein, any such function may be referred to as a “cumulative reward function”. Therefore, computing a best or optimal cumulative reward function may be equivalent to finding a best or optimal policy for the agent. The agent and its interaction with the environment may be formulated as one or more Markov Decision Processes (MDPs). The RL procedure may not assume knowledge of an exact mathematical model of the MDPs. The MDPs may be completely unknown, partially known, or completely known to the agent. The RL procedure may sit in a spectrum between the two extents of “model-based” or “model-free” with respect to prior knowledge of the MDPs. As such, the RL procedure may target large MDPs where exact methods may be infeasible or unavailable due to an unknown or stochastic nature of the MDPs. Examples of function approximators may include neural networks (such as deep neural networks) and probabilistic graphical models (e.g. Boltzmann machines, Helmholtz machines, and Hopfield networks). A function approximator may create a parameterization of an approximation of the cumulative reward function. Optimization of the function approximator with respect to its parameterization may consist of perturbing the parameters in a direction that enhances or maximizes the cumulative rewards and therefore enhances or optimizes the policy (such as in a policy gradient method), or by perturbing the function approximator to get closer to satisfy Bellman's optimality criteria (such as in a temporal difference method).

After an iteration of the annealing is done, the ML or RL algorithm can use the parameters and the solution of the current iteration and/or previous iterations, if any, to generate a next best guess for the parameters that can further minimize the cost function. The data provided to the ML or RL algorithm can include a list of tuples where each tuple includes a value for each parameter used, and a value that is an indication of the result (e.g., cost) observed by running the annealing with those parameters.

After the list of parameters and solutions is updated or recalculated, the systems and methods described herein may start a new iteration of the adiabatic quantum computation by running the annealing algorithm in operation 112 and repeating the operations thereafter (e.g., operations 114, 116, method 200, and operation 122 or operations 114, 116, method 200, operations 118 and 120) using the updated list of parameters and solutions. This process can be repeated until the obtained energy is sufficiently accurate.

### Quantum and Digital Computers

The present disclosure herein may include quantum hardware, a quantum computer, a quantum device, or use of the same. Quantum computation can use quantum bits (qubits), which can be in superpositions of states. A quantum Turing machine can be a theoretical model of such a computer, and is also known as a universal quantum computer. Quantum computers may share theoretical similarities with non-deterministic and probabilistic computers. A quantum computer described herein may comprise one or more quantum processors. A quantum computer may be configured to perform one or more quantum algorithms. A quantum computer may store or process data represented by quantum bits (qubits). A quantum computer may be able to solve certain problems much more quickly than any classical computers that use even the best currently available algorithms, like integer factorization using Shor's algorithm or the simulation of quantum many-body systems. There exist quantum algorithms, such as Simon's algorithm, that may run faster than any possible probabilistic classical algorithm. Examples of quantum algorithms include, but are not limited to, quantum optimization algorithms, quantum Fourier transforms, amplitude amplifications, quantum walk algorithms, and quantum evolution algorithms. Quantum computers may be able to efficiently solve problems that no classical computer may be able to solve within a reasonable amount of time. Thus, a system disclosed herein utilizes the merits of quantum computing resources to solve complex problems.

Any type of quantum computers may be suitable for the technologies disclosed herein. Examples of quantum computers include, but are not limited to, adiabatic quantum computers, quantum gate arrays, one-way quantum computer, topological quantum computers, quantum Turing machines, superconductor-based quantum computers, trapped ion quantum computers, optical lattices, quantum dot computers, spin-based quantum computers, spatial-based quantum computers, Loss-DiVincenzo quantum computers, nuclear magnetic resonance (NMR) based quantum computers, liquid-NMR quantum computers, solid state NMR Kane quantum computers, electrons-on-helium quantum computers, cavity-quantum-electrodynamics based quantum computers, molecular magnet quantum computers, fullerene-based quantum computers, linear optical quantum computers, diamond-based quantum computers, Bose-Einstein condensate-based quantum computers, transistor-based quantum computers, and rare-earth-metal-ion-doped inorganic crystal based quantum computers. A quantum computer may comprise one or more of: a quantum annealer, an Ising solver, an optical parametric oscillator (OPO), or a gate model of quantum computing.

The term “quantum annealer” and like terms may generally refer to a system of superconducting qubits that carries optimization of a configuration of spins in an Ising spin model using quantum annealing, as described, for example, in Farhi, E. et al., “Quantum Adiabatic Evolution Algorithms versus Simulated Annealing” arXiv.org: quant ph/0201031 (2002), pp. 1-16. An embodiment of such an analog processor is disclosed by McGeoch, Catherine C. and Cong Wang, (2013), “Experimental Evaluation of an Adiabatic Quantum System for Combinatorial Optimization” Computing Frontiers,” May 14-16, 2013 (http://www.cs.amherst.edu/ccm/cf14-mcgeoch.pdf) and also disclosed in U.S. Patent Application Publication Number US 2006/0225165, which is entirely incorporated herein by reference.

In some cases, a classical simulator of a quantum circuit can be used which can run on a classical computer like a MacBook Pro laptop, a Windows laptop, or a Linux laptop. In some embodiments, the classical simulator can run on a cloud computing platform having access to multiple computing nodes in a parallel or distributed manner.

The quantum computer disclosed herein may be operatively coupled to a digital computer over a network. The quantum computer may be configured to perform one or more quantum algorithms for solving a computational problem. The digital computer (interchangeable as a digital processing device) may comprise at least one computer processor and computer memory, wherein the digital computer may include a computer program with instructions executable by the at least one computer processor to render an application. The application may facilitate use of the quantum computer by a user.

Some implementations may use quantum computers along with classical computers operating on bits, such as personal desktops, laptops, supercomputers, distributed computing, clusters, cloud-based computing resources, smartphones, or tablets.

The system may comprise an interface for a user. Such interface may comprise an application programming interface (API). The interface may provide a programmatic model that abstracts away (e.g., by hiding from the user) the internal details (e.g., architecture and operations) of the quantum computer. The interface may minimize a need to update the application programs in response to changing quantum hardware. The interface may remain unchanged when the quantum computer has a change in internal structure.

Although the present disclosure has made reference to quantum computers, methods and systems of the present disclosure may be employed for use with other types of computers, which may be non-classical computers. Such non-classical computers may comprise quantum computers, hybrid quantum computers, quantum-type computers, or other computers that are not classical computers. Examples of non-classical computers may include, but are not limited to, Hitachi Ising solvers, coherent Ising machines based on optical parameters, and other solvers which utilize different physical phenomena to obtain more efficiency in solving particular classes of problems.

The present disclosure provides computer systems that are programmed to implement methods of the disclosure. Such computer systems may be or include digital computers.

FIG. 3 shows an example of a system 300 comprising a digital computer interacting with a system of superconducting qubits. The system may comprise a digital computer 302 and a system 322 of superconducting qubits. The digital computer 302 may be in communication with the system of quantum computing device 322 including superconducting qubits for transmitting and/or receiving data therefrom. The digital computer and the superconducting qubits may be remotely located from each other. The digital computer 202 can be selected from a group consisting of desktop computers, laptop computers, tablet PCs, servers, smartphones, etc. The digital computer 302 may comprise a central processing unit (CPU) 304, also referred to as a microprocessor, a display device 306, input devices 308, communication ports 310, a data bus 312, a memory unit 314, and a network interface card (NIC) 320. The CPU 304 may be single-core or a multi-core CPU.

The CPU 304 can be part of a circuit, such as an integrated circuit. One or more other components of the system can be included in the circuit. In some cases, the circuit is an application specific integrated circuit (ASIC).

The CPU 304 may be used for processing computer instructions. Various embodiments of the CPU 304 may be provided. The central processing unit 304 may be a CPU Core i7-3820 operating at 3.6 GHz and manufactured by Intel™, for example.

The display device 306 may be used for displaying data to a user. Various types of display device 304 may be used. In some embodiments, the display device 306 is a standard liquid-crystal display (LCD) monitor.

The communication ports 310 may be used for sharing data with the digital computer 302. The communication ports 310 may comprise, for instance, a universal serial bus (USB) port for connecting a keyboard and a mouse to the digital computer 302. The communication ports 310 may further comprise a data network communication port such as an IEEE 802.3 port for enabling a connection of the digital computer 302 with another computer via a data network. Various alternative embodiments of the communication ports 310 may be provided. In some embodiments, the communication ports 310 comprise an Ethernet port and a mouse port (e.g., Logitech™.

The memory unit 314 is used for storing computer-executable instructions. The memory unit 314 comprises, in some embodiments, an operating system module 316. The operating system module 316 may be of various types. In some embodiments, the operating system module 316 is OS X High Sierra manufactured by Apple™.

The memory unit 314 may further comprise one or more applications for each of the central processing unit 304, the display device 306, the input devices 308, the communication ports 310 and the memory unit 314 interconnected via the data bus 312.

The system 302 may further comprise a network interface card (NIC) 320. The application 316 may send the appropriate signals along the data bus 312 into NIC 320. NIC 320, in turn, may send such information to quantum device control system 324. The digital computer 302 can communicate with one or more remote computer systems through a network. For instance, the computer system can communicate with a remote computer system of a user. Examples of remote computer systems include personal computers (e.g., portable PC), slate or tablet PC's (e.g., Apple® iPad, Samsung® Galaxy Tab), telephones, Smart phones (e.g., Apple® iPhone, Android-enabled device, Blackberry®), or personal digital assistants. The user can access the computer system 302 via the network, e.g., Internet. The digital computer can be connected to the Internet such that it accesses the World Wide Web. The digital computer may be connected to a cloud computing infrastructure, an intranet and/or a data storage device.

The system 322 of superconducting qubits may comprise a plurality of superconducting quantum bits and a plurality of coupling devices. Further description of such a system is disclosed in U.S. Patent Application Publication No. 2006/0225165, which is entirely incorporated herein by reference.

The system 322 may further comprise a quantum device control system 324 and a quantum processor or a quantum computer 330. The control system 324 itself may comprise a coupling controller for each coupling in a plurality 328 of couplings of the device 322 capable of tuning the coupling strengths of a corresponding coupling, and local field bias controller for each qubit in the plurality 326 of qubits of the device 322 capable of setting a local field bias on each qubit.

Methods described herein can be implemented by way of machine (e.g., computer processor) executable code stored on an electronic storage location of the computer system, such as, for example, on the memory unit 314 or an electronic storage unit. The machine executable or machine readable code can be provided in the form of software. During use, the code can be executed by the CPU 304. In some cases, the code can be retrieved from the electronic storage unit and stored on the memory unit 314 for ready access by the CPU 304. In some situations, the electronic storage unit can be precluded, and machine-executable instructions are stored on memory unit 314.

The code can be pre-compiled and configured for use with a machine having a processer adapted to execute the code, or can be compiled during runtime. The code can be supplied in a programming language that can be selected to enable the code to execute in a pre-compiled or as-compiled fashion.

Aspects of the systems and methods provided herein, such as the computer system 302 and/or 322, can be embodied in programming. Various aspects of the technology may be thought of as “products” or “articles of manufacture” typically in the form of machine (or processor) executable code and/or associated data that is carried on or embodied in a type of machine readable medium. Machine-executable code can be stored on an electronic storage unit, such as memory (e.g., read-only memory, random-access memory, flash memory) or a hard disk. “Storage” type media can include any or all of the tangible memory of the computers, processors or the like, or associated modules thereof, such as various semiconductor memories, tape drives, disk drives and the like, which may provide non-transitory storage at any time for the software programming. All or portions of the software may at times be communicated through the Internet or various other telecommunication networks. Such communications, for example, may enable loading of the software from one computer or processor into another, for example, from a management server or host computer into the computer platform of an application server. Thus, another type of media that may bear the software elements includes optical, electrical and electromagnetic waves, such as used across physical interfaces between local devices, through wired and optical landline networks and over various air-links. The physical elements that carry such waves, such as wired or wireless links, optical links or the like, also may be considered as media bearing the software. As used herein, unless restricted to non-transitory, tangible “storage” media, terms such as computer or machine “readable medium” refer to any medium that participates in providing instructions to a processor for execution.

Hence, a machine readable medium, such as computer-executable code, may take many forms, including but not limited to, a tangible storage medium, a carrier wave medium or physical transmission medium. Non-volatile storage media include, for example, optical or magnetic disks, such as any of the storage devices in any computer(s) or the like, such as may be used to implement the databases, etc. shown in the drawings. Volatile storage media include dynamic memory, such as main memory of such a computer platform. Tangible transmission media include coaxial cables; copper wire and fiber optics, including the wires that comprise a bus within a computer system. Carrier-wave transmission media may take the form of electric or electromagnetic signals, or acoustic or light waves such as those generated during radio frequency (RF) and infrared (IR) data communications. Common forms of computer-readable media therefore include for example: a floppy disk, a flexible disk, hard disk, magnetic tape, any other magnetic medium, a CD-ROM, DVD or DVD-ROM, any other optical medium, punch cards paper tape, any other physical storage medium with patterns of holes, a RAM, a ROM, a PROM and EPROM, a FLASH-EPROM, any other memory chip or cartridge, a carrier wave transporting data or instructions, cables or links transporting such a carrier wave, or any other medium from which a computer may read programming code and/or data. Many of these forms of computer readable media may be involved in carrying one or more sequences of one or more instructions to a processor for execution.

Methods and systems of the present disclosure can be implemented by way of one or more algorithms. An algorithm can be implemented by way of software upon execution by the central processing unit 304.

A digital computer 302 disclosed herein can be a classical computer that does not comprise a quantum computer or any other quantum hardware. A digital computer may process or store data represented by digital bits (e.g., zeroes (“0”) and ones (“1”)) rather than quantum bits (qubits). Examples of digital computers include, but are not limited to, server computers, desktop computers, laptop computers, notebook computers, sub-notebook computers, netbook computers, netpad computers, set-top computers, media streaming devices, handheld computers, Internet appliances, mobile smartphones, tablet computers, personal digital assistants, video game consoles, and vehicles.

A classical computer may be configured to perform one or more classical algorithms and/or solve one or more classical optimization problems. A classical optimization problem (or classical computational task) may be solved by one or more classical computers without the use of a quantum computer or any other quantum hardware. A classical optimization problem may be a non-quantum optimization problem.

A classical computer may be configured to perform one or more classical algorithms. A classical algorithm (or classical computational task) may be an algorithm (or computational task) that is able to be executed by one or more classical computers without the use of a quantum computer, a quantum-ready computing service, or a quantum-enabled computing service. A classical algorithm may be a non-quantum algorithm. A classical computer may be a computer which does not comprise a quantum computer, a quantum-ready computing service, or a quantum-enabled computer. A classical computer may process or store data represented by digital bits (e.g., zeroes (“0”) and ones (“1”)) rather than quantum bits (qubits). Examples of classical computers include, but are not limited to, server computers, desktop computers, laptop computers, notebook computers, sub-notebook computers, netbook computers, netpad computers, set-top computers, media streaming devices, handheld computers, Internet appliances, mobile smartphones, tablet computers, personal digital assistants, video game consoles, and vehicles.

A quantum-ready computing system may comprise a digital computer operatively coupled to a non-classical (e.g., quantum) computer. The non-classical computer may be configured to perform one or more non-classical algorithms, such as one or more quantum algorithms. A quantum-enabled computing system may comprise a non-classical (e.g., quantum) computer and a classical computer. The non-classical computer and the classical computer may be operatively coupled to a digital computer. The non-classical computer may be configured to perform one or more non-classical algorithms for solving a computational problem. The classical computer may comprise at least one classical processor and computer memory, and may be configured to perform one or more classical algorithms for solving a computational problem.

The present disclosure provides systems, and methods that may allow quantum-enabled computing or use quantum-enabled computing. Quantum computers may be able to solve certain classes of computational tasks more efficiently than classical computers. However, quantum computation resources may be rare and expensive, and may involve a certain level of expertise to be used efficiently or effectively (e.g., cost-efficiently or cost-effectively). A number of parameters may be tuned in order for a quantum computer to deliver its potential computational power.

Quantum computers (or other types of non-classical computers) may be able to work alongside classical computers as co-processors. A hybrid architecture of quantum-enabled computation can be very efficient for addressing complex computational tasks, such as hard optimization problems. Systems and methods disclosed herein may provide a remote interface capable of solving computationally expensive problems by deciding if a problem may be solved efficiently on a quantum-ready or a classical computing service. The computing service behind the interface may be able to efficiently and intelligently decompose or break down the problem and delegate appropriate components of the computational task to a quantum-ready or a classical service.

The methods and systems described here may comprise an architecture configured to realize a cloud-based framework to provide hybrid quantum-enabled computing solutions to complex computational problems (such as complex discrete optimization) using a classical computer for some portion of the work and a quantum (or quantum-like) computer (e.g., quantum-ready or quantum-enabled) for the remaining portion of the work.

Quantum-ready and quantum-enabled computation may be as described in, for example, U.S. Pat. Nos. 9,870,273 and 10,152,358, each of which is entirely incorporated herein by reference

### EXAMPLES

The following illustrative examples are representative of embodiments of the software applications, systems, and methods described herein and are not meant to be limiting.

### Example 1: Estimation of Molecular Energies

The estimation of molecular energies was performed using the systems and methods described herein. A system with a single hydrogen molecule (H₂ molecule) and a system with two hydrogen molecules placed parallel to each other (P4 molecule) were both considered. In this example, the second quantized molecular Hamiltonian was used. The molecular Hamiltonian was used as a final Hamilton. The initial Hamiltonian was determined as:

Hᵢₙᵢₜᵢₐₗ=−Σ_{p∈occupied}ηₚ\hat{α}ₚ^{†}\hat{α}ₚ−Σ_{p∈empty}η_{α}\hat{α}_{α}^{†}\hat{α}_{α} (10)

where p represents orbital of occupied energy level in the atomic orbital and a represents spin-orbital of empty energy level in the atomic orbital. ηₚ and η_{α} are variational parameters.

The intermediate Hamiltonian was selected as:

H_{Intermediate}=Σ_{p,α}h^{excitation}+\hat{α}_{α}^{†}αₚ+Σ_{p,q,α,β}h_{pqαβ}^{excitation}\hat{α}_{α}^{†}\hat{α}_{β}^{†}\hat{α}ₚ\hat{α}_{q}+h.c. (11)

The h_{pα}^{excitation} were variational parameters. The annealing schedule was set to be

$$H ( t ) = ( 1 - \frac{t}{T} ) {H}_{initial} + 0.6 \times \frac{t}{T} ( 1 - \frac{t}{T} ) {H}_{intermediate} + \frac{t}{T} {H}_{final} \qquad ( 12 )$$

As for the encoding scheme, one qubit was assigned for each spin-orbital. The initial values of parameters h_{pα}^{expectation} were set as zero. For each given parameter, h_{pα}^{excitation} with a specific p, a pair, a time-dependent Hamiltonian (12) was solved on a classical computer and then a cost function was obtained which is an expectation value of the molecular Hamiltonian, [symbol] H_{final} [symbol] .

More concretely, an eigenstate of Hᵢₙᵢₜᵢₐₗ was obtained, where

Hᵢₙᵢₜᵢₐₗ|ψ(0) [symbol] =E₀|ψ(0) [symbol] (13)

The time evolution

|ψ(T) [symbol] = [symbol] ₑ^{-i∫}^{₀}^{^{T}}^{dtH(t)}|ψ(0) [symbol] (14)

was computed and the energy E

E= [symbol] ψ(T)|H_{final}|ψ(T) [symbol] (15)

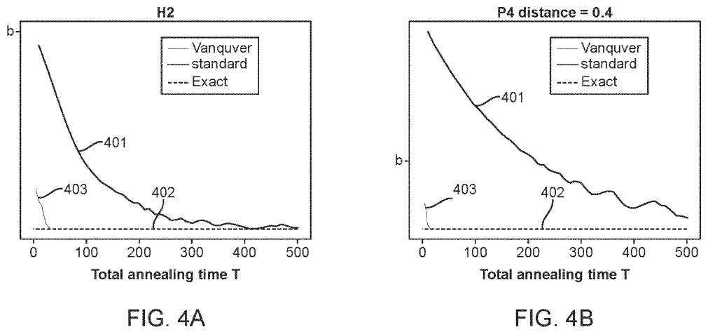

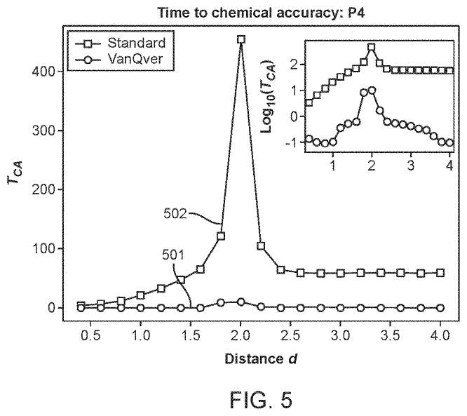

was evaluated. The information of h_{p∝}^{expectation} parameters and the obtained energy [symbol] H_{final} [symbol] were sent to a classical optimizer (constrained optimization by linear approximation, COBYLA), which generated a new set of parameters h_{p∝}^{expectation}. Then a quantum annealing algorithm was performed for one iteration. The energy, [symbol] H_{final} [symbol] was compared to a predetermined threshold and the process was reiterated for one or more additional iterations until the energy reaches an optimal value or satisfies the predetermined threshold. The obtained results are shown in FIGS. 4A-4B. The horizontal axis represents the total annealing time and the vertical axis represents the obtained energy. The lines 401 in FIG. 4A and 404 in FIG. 4B represent the result of the energy estimation without using the systems and methods described herein. The estimated energy becomes lower as the total annealing time is increased. This is because the adiabaticity condition is satisfied if the total annealing time is longer, or the change of the parameters in the time dependent Hamiltonian is slower. While it eventually reaches very close to the true ground state of the final Hamiltonian, the required total annealing time may be quite long. The lines 403 in FIG. 4A and 406 in FIG. 4B represent the results obtained by using the systems and methods described herein which converges and substantially overlaps with the broken line 402 in FIG. 4A and 405 in FIG. 4B indicating the exact value. It clearly shows that with the systems and methods in the present disclosure, the estimated energy reaches the exact value with a much shorter annealing time (10× shorter). The required single run annealing time to achieve chemical accuracy is shown in FIG. 5. The line 502 represents the result obtained without using the methods described herein for P4, whereas the line 501 represents the results obtained by using the methods described herein. The annealing time is two to three orders of magnitude smaller with the methods described herein.

H_{intermediate} plays a significant role to improve the computational results. In order to see this, two quantities were investigated: the energy gap between the instantaneous ground state and the first excited state, and the overlap between the instantaneous ground state and the quantum state generated in the annealing. The former is used in the adiabatic condition. The latter captures dynamical aspects of the annealing.

With the optimal value of the variational parameters (η,h^{excitation}) for a given annealing time T, the ith excited instantaneous eigenstates |ϕᵢ(t) [symbol] and the eigenvalues Eᵢ(t) were defined as

H_{(η,h}_{^{excitation}}₎(t)|ϕᵢ(t) [symbol] =Eᵢ(t)|ϕᵢ(t) [symbol] (16)

Here, the spin-orbital indices p, a in the variational parameters are omitted.

In order to understand the role of H_{intermediate}, simulations without the intermediate Hamiltonian H_{intermediate}, h^{excitation}=0 were performed:

H_{(η,h}_{^{excitation}}₌₀₎(t)|ϕᵢ^{NoNav}(t) [symbol] =Eᵢ^{NoNav}(t)|ϕᵢ^{NoNav}(t) [symbol] (17)

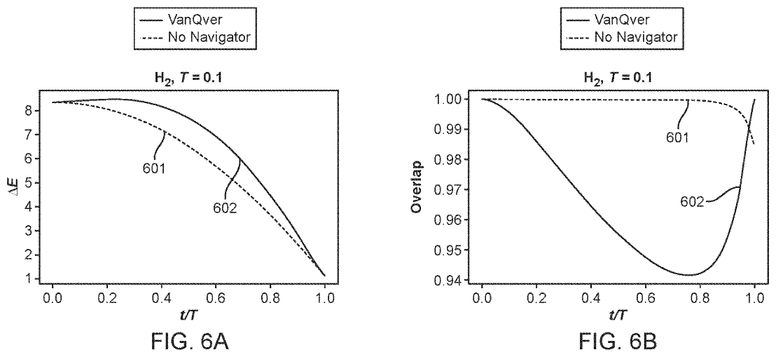

The line 602 in FIG. 6A. shows the energy gap ΔE=E₁(t)−E₀ (t) with the methods described herein, and the dotted line 601 shows the energy gap ΔE^{NoNav}=E₁^{NoNav}(t)−E₀^{NoNav}(t) without the methods described herein for the hydrogen molecule with T=0.1. FIG. 6A indeed describes that the H_{intermediate} increases the energy gap during the entire annealing schedule.

Next, the wavefunction overlap was analyzed. The wavefunctions generated in the annealing were

|ψ(t) [symbol] = [symbol] exp(−i∫₀^{t}H_{(η,h}_{^{excitation}}₎(s)ds)|ψ⁽⁰⁾ (18)

for the methods described herein and

|ψ^{NoNav}(t) [symbol] = [symbol] exp(−i∫₀^{t}H_{(η,h}_{^{excitation}}₌₀₎(s)ds)|ψ⁽⁰⁾ [symbol] (19)

without the use of H_{intermediate}. In order to understand how close these states are to the instantaneous ground states, the overlaps, | [symbol] (ϕ₀(t)|ψ(t) [symbol] | and | [symbol] ϕ₀^{NoNav}(t)|ψ^{NoNav}(t) [symbol] | were computed. The results for the hydrogen molecule with T=0.1 are shown in FIG. 6B. The dotted line 603 represents the result without the methods described herein, whereas the line 604 represents the result with the methods described herein. The wavefunction overlap in the methods described herein becomes very close to 1 for T>T_{CA}^{VanQver}. The overlap in the methods described herein may decrease in the middle of the annealing and increases towards the end of the annealing. On the other hand, in the case of no H_{intermediate}, the overlap may decrease monotonically, and in particular drops rapidly near the end of the annealing. The overlap in the methods described herein may take smaller values except near the end of the annealing. In some cases, partially use excited states may be used in the middle of the annealing so that the wavefunction fully comes back to the ground state at the end of the annealing where the energy gap becomes small.

Quantum states are fragile and susceptible to noise. The disclosed method shows some form of noise resilience, which is necessary for successful quantum computing. The most general trace-preserving completely positive form of the open system time evolution is given by the Lindblad master equation:

$$\frac{d ρ}{dt} = - i [ H , ρ ] + {Σ}_{i} ( {C}_{i} ρ {C}_{i}^{†} - \frac{1}{2} \{ {C}_{i}^{†} {C}_{i} , ρ \} ) \qquad ( 20 )$$

Cᵢ are called collapse operators. Let us consider a hydrogen molecule and choose the following collapse operators

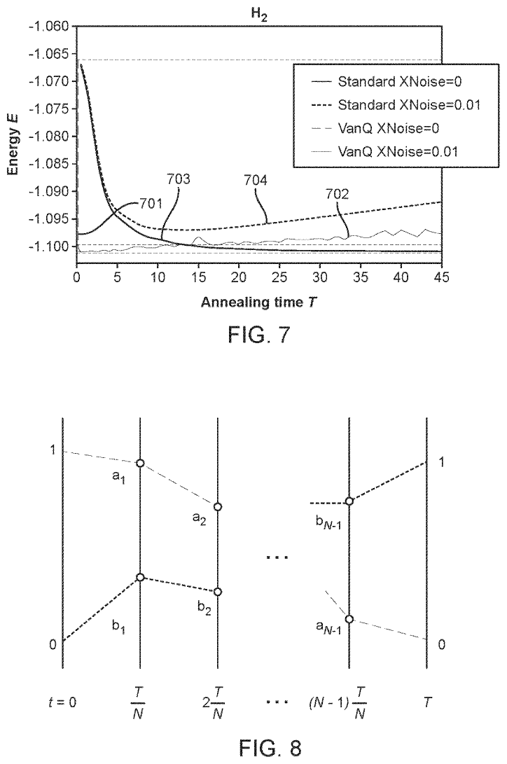

ε_{X}=α(X₀+X₁+X₂X₃) (21)

where α is the strength of the noise. In FIG. 7, the computational results with and without the methods described herein are shown. The line 701 is for the methods described herein with no noise, and the line 702 is for the methods described herein with noise strength 0.01. The line 703 is the result without the methods described herein, with no noise. The line 704 is the result without the methods described herein, with noise strength 0.01. In the methods described herein, the estimated energy reaches the chemical accuracy before the noise destroys the quantum information, whereas the result without the methods described herein fails to achieve chemical accuracy. Furthermore, the rate of losing information while using the methods described herein is slower compared to the result obtained without the methods described herein.

Another embodiment to use the disclosed algorithm is to find the optimal schedule variationally. For simplicity, let us consider only the initial Hamiltonian and the final Hamiltonian. It is straightforward to include the intermediate Hamiltonian. The initial Hamiltonian and the final Hamiltonian consist of various terms. Let us denote them as

Hᵢₙᵢ=Σᵢ₌₁^{M}^{ᵢₙᵢ}=Jᵢσᵢₙᵢⁱ,H_{fin}=Σⱼ₌₁^{M}^{_{fin}}Jⱼσ_{fin}^{j} (22)

where σⁱ are tensor products of Pauli matrices. We group the terms of the initial and the final Hamiltonians into Kᵢₙᵢ and K_{fin} groups.

Hᵢₙᵢ=Σᵢ₌₁^{K}^{ᵢₙᵢ}σᵢₙᵢⁱ,H_{fin}=Σⱼ₌₁^{K}^{_{fin}}σ_{fin}^{j} (23)

Then the following Hamiltonian is considered:

$$H = {\sum }_{i = 1}^{{K}_{ini}} {A}_{i} ( t ) {𝒪}_{ini}^{i} + {\sum }_{j = 1}^{{K}_{fin}} {B}_{j} ( t ) {𝒪}_{fin}^{j}$$

The time dependent coefficients Aᵢ(t) and Bⱼ(t) are determined variationally. In an embodiment, as shown in FIG. 8, the annealing time T was split into N intervals. In each time interval, the coefficients Aᵢ(t) and Bᵢ(t) were determined by using variational parameters αᵢ⁽ⁿ⁾ and bᵢ⁽ⁿ⁾ as

$$\begin{matrix}{A}_{i} ( t ) = \frac{{a}_{i}^{( n )} - {a}_{i}^{( n - 1 )}}{T \text{/} N} ( t - ( n - 1 ) \frac{T}{N} ) + {a}_{i}^{( n - 1 )} & ( 24 ) \\ {B}_{i} ( t ) = \frac{{b}_{i}^{( n )} - {b}_{i}^{( n - 1 )}}{T \text{/} N} ( t - ( n - 1 ) \frac{T}{N} ) + {b}_{i}^{( n - 1 )} & ( 25 )\end{matrix}$$

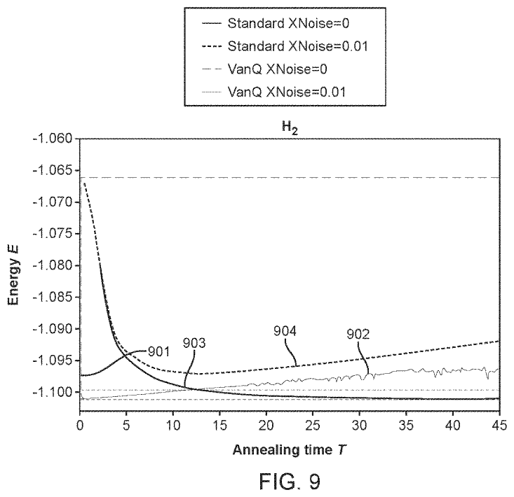

for the time interval

$$( n - 1 ) \frac{T}{N} \leq t < n \frac{T}{N} ,$$

where n runs from 1 to N. αᵢ⁽ⁿ⁾ and bᵢ⁽ⁿ⁾ with 1≤n≤(N−1) are variational parameters. αᵢ^{(N)}=0 and bᵢ^{(N)}=1 form the boundary conditions. FIG. 9 shows that this method shortens the required computational time by orders of magnitude. The line 901 depicts the methods described herein with no noise, and the line 902 depicts the methods described herein with noise strength 0.01. The line 903 is the result without the method described herein, with no noise. The line 904 is the result without the method described herein, with noise strength 0.01. Furthermore, 902 exhibits noise resilience.

The disclosed algorithm can also be used as a variational error correction method. In some embodiments, a recovery operators Rᵢ can be added in addition to Hᵢₙᵢₜᵢₐₗ, H_{intermediate}, H_{final} that are used above. Rᵢ may be products of Pauli matrices. The system may or may not be encoded. A variational error correction method with the methods described herein uses the following time dependent Hamiltonian:

H(t)=A(t)Hᵢₙᵢₜᵢₐₗ+B(t)H_{final}+C(t)H_{intermediate}+ΣᵢDᵢ(t)Rᵢ (26)

The functions A (t), B (t), C (t) are fixed, whereas Dᵢ(t) are determined variationally. The coefficients in Hᵢₙᵢₜᵢₐₗ and H_{intermediate} are also determined variationally.

While preferred embodiments of the present invention have been shown and described herein, it will be obvious to those skilled in the art that such embodiments are provided by way of example only. It is not intended that the invention be limited by the specific examples provided within the specification. While the invention has been described with reference to the aforementioned specification, the descriptions and illustrations of the embodiments herein are not meant to be construed in a limiting sense. Numerous variations, changes, and substitutions will now occur to those skilled in the art without departing from the invention. Furthermore, it shall be understood that all aspects of the invention are not limited to the specific depictions, configurations or relative proportions set forth herein which depend upon a variety of conditions and variables. It should be understood that various alternatives to the embodiments of the invention described herein may be employed in practicing the invention. It is therefore contemplated that the invention shall also cover any such alternatives, modifications, variations or equivalents. It is intended that the following claims define the scope of the invention and that methods and structures within the scope of these claims and their equivalents be covered thereby.

1.-36. (canceled)

37. A computer-implemented method for solving an optimization problem using a computing platform comprising at least one non-classical computer and at least one digital computer, comprising:
(a) determining, by said at least one digital computer, one or more first parameters of a first Hamiltonian;
(b) using said one or more first parameters to configure a second Hamiltonian different than said first Hamiltonian;
(c) using said at least one non-classical computer to execute said second Hamiltonian to obtain a solution of said second Hamiltonian;
(d) processing said solution to determine a value of a cost function associated with (i) said second Hamiltonian or (ii) execution of said second Hamiltonian by said at least one non-classical computer; and
(e) subsequent to (d), (i) outputting a result indicative of said solution if said value meets a threshold value, or (ii) using one or more second parameters to reconfigure said second Hamiltonian, which one or more second parameters are different than said one or more first parameters.

38. The method of claim 37, wherein said first Hamiltonian comprises an intermediate Hamiltonian.

39. The method of claim 37, wherein said second Hamiltonian comprises a final Hamiltonian.

40. The method of claim 37, wherein said second Hamiltonian comprises a plurality of different types of Hamiltonians.

41. The method of claim 37, wherein one or more coefficients of said final Hamiltonian are time-dependent.

42. The method of claim 37, wherein one or more coefficients of said final Hamiltonian are time-independent.

43. The method of claim 37, wherein said one or more parameters of said first Hamiltonian comprise one or more variational parameters.

44. The method of claim 37, further comprising, prior to (a), receiving, by said at least one digital computer, a cost function of said optimization problem.

45. The method of claim 37, further comprising, prior to (a), initializing, by said at least one digital computer, a list of parameters and solutions.

46. The method of claim 45, wherein (a) comprises (i) setting said list of parameters and solutions to zero for an initial iteration; (ii) updating, by said at least one digital computer, said list of parameters and solutions with said one or more parameters, and said solution for an iteration subsequent to said initial iteration.

47. The method of claim 37, further comprising, prior to (a), determining said first Hamiltonian.

48. The method of claim 47, wherein determining said first Hamiltonian is based at least in part on use of one or more members selected from the group consisting of said optimization problem, a cost function of said optimization problem, and a final Hamiltonian related to said cost function.

49. The method of claim 37, wherein (a) comprises using one or more optimizers selected from the group consisting of a Bayesian optimization method, black-box optimization, gradient-free optimization, gradient-based optimization, a first-order or second-order method, a gradient descent method, a stochastic gradient decent method, an adaptive gradient descent method, a Nelder-Mead method, a Powell method, constrained optimization by linear approximation (COBYLA), and a Broyden-Fletcher-Goldfarb-Shanno (BFGS) method.

50. The method of claim 37, wherein (a) comprises using one or more artificial intelligence (AI) algorithms to determine said one or more parameters of said first Hamiltonian.

51. The method of claim 37, wherein (b) comprises determining a schedule for changing said one or more parameters of at least one of said first Hamiltonian and of said second Hamiltonian.

52. The method of claim 51, wherein (c) is performed based at least in part on said schedule.

53. The method of claim 37, wherein (c) comprises determining an encoding scheme variationally and obtaining information of said encoding scheme.

54. The method of claim 37, wherein (c) comprises obtaining a qubit Hamiltonian of at least one of said first Hamiltonian and said second Hamiltonian.

55. The method of claim 37, wherein (c) comprises (i) preparing an initial state of one or more qubits of said at least one non-classical computer and (ii) performing adiabatic quantum computation on an optimization device.

56. The method of claim 55, wherein said optimization device is a quantum annealer or a digital annealer.

57. The method of claim 55, wherein (c) comprises generating a result state of said one or more qubits and obtaining one or more measurements of said result state, thereby obtaining said solution.

58. The method of claim 37, wherein said non-classical computer is a quantum computer, a quantum-ready or a quantum-enabled computer.

59. The method of claim 37, wherein said optimization problem comprises one or more members selected from the group consisting of a non-classical optimization problem and a classical optimization problem.

60. A system for solving an optimization problem comprising:
a computing platform comprising at least one non-classical computer and at least one digital computer;
computer memory; and
one or more computer processors operatively coupled to said computer memory, wherein said one or more computer processors are individually or collectively programmed to:
(a) determine, by said at least one digital computer, one or more first parameters of a first Hamiltonian;
(b) use said one or more parameters to configure a second Hamiltonian different than said first Hamiltonian;
(c) use said at least one non-classical computer to execute said second Hamiltonian to obtain a solution of said second Hamiltonian;
(d) process said solution to determine a value of a cost function associated with (i) said second Hamiltonian or (ii) execution of said second Hamiltonian by said at least one non-classical computer; and
(e) subsequent to (d), (i) output a result indicative of said solution if said value meets a threshold value, or (ii) use one or more second parameters to reconfigure said second Hamiltonian, which one or more second parameters are different than said one or more first parameters.
